(19) United States
(12) Patent Application Publication
(10) Pub. No.: US 2018/0233146 A1
(43) Pub. Date: Aug. 16, 2018

(54) Voice Recognition Alert Notification Apparatus, System and Method

(71) Applicant: Theresa Gray-Pedersen, Crystal Lake, IL (US)

(72) Inventor: Theresa Gray-Pedersen, Crystal Lake, IL (US)

(21) Appl. No.: 15/844,304

(22) Filed: Dec. 15, 2017

Related U.S. Application Data
(60) Provisional application No. 62/434,667, filed on Dec. 15, 2016.

(51) Int. Cl. G10L 15/22; G10L 25/51; G08B 21/18

(52) U.S. Cl. CPC G10L 15/22; G08B 21/182; G10L 25/51

(57) ABSTRACT

The present invention relates to a voice recognition alert notification apparatus, system and methods of using the same. Specifically, the voice recognition alert notification apparatus comprises a device having an audio listening element that is programmed to identify the voice pattern of a particular individual, such that when the loudness of a particular individual's voice rises to a particular pre-defined level, the alert notification apparatus sends a signal to the individual. The present invention may be particularly useful in situations where an individual, such as a child, is learning to control the loudness level of his or her voice.

### TECHNICAL FIELD

The present invention relates to a voice recognition alert notification apparatus, system and methods of using the same. Specifically, the voice recognition alert notification apparatus comprises a device having an audio listening element that is programmed to identify the voice pattern of a particular individual, such that when the loudness of a particular individual's voice rises to a particular pre-defined threshold level, the alert notification apparatus sends a signal to the individual. The present invention may be particularly useful in situations where an individual, such as a child, is learning to control the loudness level of his or her voice.

### BACKGROUND

When an individual becomes excited, whether out of joy or anger, his or her voice may suddenly rise in loudness. Oftentimes, especially in children, this can happen suddenly and without much forethought on the part of the child. This may be especially true in individuals who may suffer from behavioral disorders, such as children with autism and the like, where the individual may raise his or her voice suddenly and oftentimes without provocation.

Oftentimes, an individual continues to speak at an elevated loudness without recognizing or knowing that he or she is doing so. In these times, another individual typically must alert the individual that he or she has raised his or her voice, and request that he or she lower his or her voice. For various reasons, it may be difficult for certain individuals to effectively communicate this to other individuals. Oftentimes, a child may not wish to be informed by the certain individual (such as a parent or sibling) that his or her voice is raised, and may proceed to maintain his or her raised voice or raise it even more. A need, therefore, exists for an apparatus that can recognize when an individual has raised his or her voice. Specifically, a need exists for an apparatus that can further alert the individual that his or her voice has been raised. More specifically, a need exists for an apparatus that can be utilized by an individual for self-regulation of his or her voice loudness and/or his or her level of excitement, anger, or other emotion.

It is also known to provide sensory alerts. For example, it is common for alert devices, such as clock alarms, phones, and other like devices, to provide an audible alert, a touch-sensitive alert, such as buzzing or vibration, and/or a visual alert, such as a flashing light or the like. A need exists for an apparatus that can alert an individual when his or her voice has risen to a pre-defined threshold level. Specifically, a need exists for an apparatus that can alert an individual using a sensory alarm, such as an audible, touch-sensitive, and/or audible alert.

Additionally, children, individuals with autism, or other like individuals may have trouble tracking tasks and completion requirements, such as when to complete such tasks, throughout the day. A need, therefore, exists for an alarm or alert system that may be set with multiple alarm settings to aid an individual with remembering what tasks to complete and when to complete them.

### SUMMARY OF THE INVENTION

The present invention relates to a voice recognition alert notification apparatus, system and methods of using the same. Specifically, the voice recognition alert notification apparatus comprises a device having an audio listening element that is programmed to identify the voice pattern of a particular individual, such that when the loudness of a particular individual's voice rises to a particular pre-defined level, the alert notification apparatus sends a signal to the individual. The present invention may be particularly useful in situations for self-regulation, such as where an individual, such as a child, is learning to control the loudness level of his or her voice or his or her level of excitement, anger or other emotion.

To this end, in an embodiment of the present invention, an apparatus is provided. The apparatus comprises a microphone, a processor, a storage module and an alerting element. The processor is programmed to recognize an individual's voice patterns and to trigger the alerting element when the individual's voice rises above a pre-defined threshold level.

In another embodiment of the present invention, a method of using an apparatus is provided. The method comprises the steps of: identifying characteristics of an individual's voice patterns by analyzing the individual's voice via the processor, storing the characteristics in the storage module, listening for the individual's voice by matching the individual's voice using the stored characteristics, and alerting the individual when the individual's voice rises above a threshold loudness level.

It is, therefore, an advantage and objective of the present invention to provide an apparatus that can recognize when an individual has raised his or her voice.

Specifically, it is an advantage and objective of the present invention to provide an apparatus that can further alert the individual that his or her voice has been raised.

More specifically, it is an advantage and objective of the present invention to provide an apparatus that can be utilized by an individual for self-regulation of his or her voice loudness and/or his or her level of excitement, anger, or other emotion.

Moreover, it is an advantage and objective of the present invention to provide an apparatus that can alert an individual when his or her voice has risen to a pre-defined level.

Specifically, it is an advantage and objective of the present invention to provide an apparatus that can alert an individual using a sensory alarm, such as an audible alarm or alert and/or non-audible touch-sensitive alert, such as a vibration.

Moreover, it is an advantage and objective of the present invention to provide an alarm or alert system that may be set with multiple alarm settings to aid an individual with remembering what tasks to complete and when to complete them.

Additional features and advantages of the present invention are described in, and will be apparent from, the detailed description of the presently preferred embodiments and from the drawings.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an apparatus for alerting an individual when the loudness of his or her voice rises above a threshold level in an embodiment of the present invention.

FIG. 2 illustrates a method for alerting an individual when the loudness of his or her voice rises above a threshold level in an embodiment of the present invention.

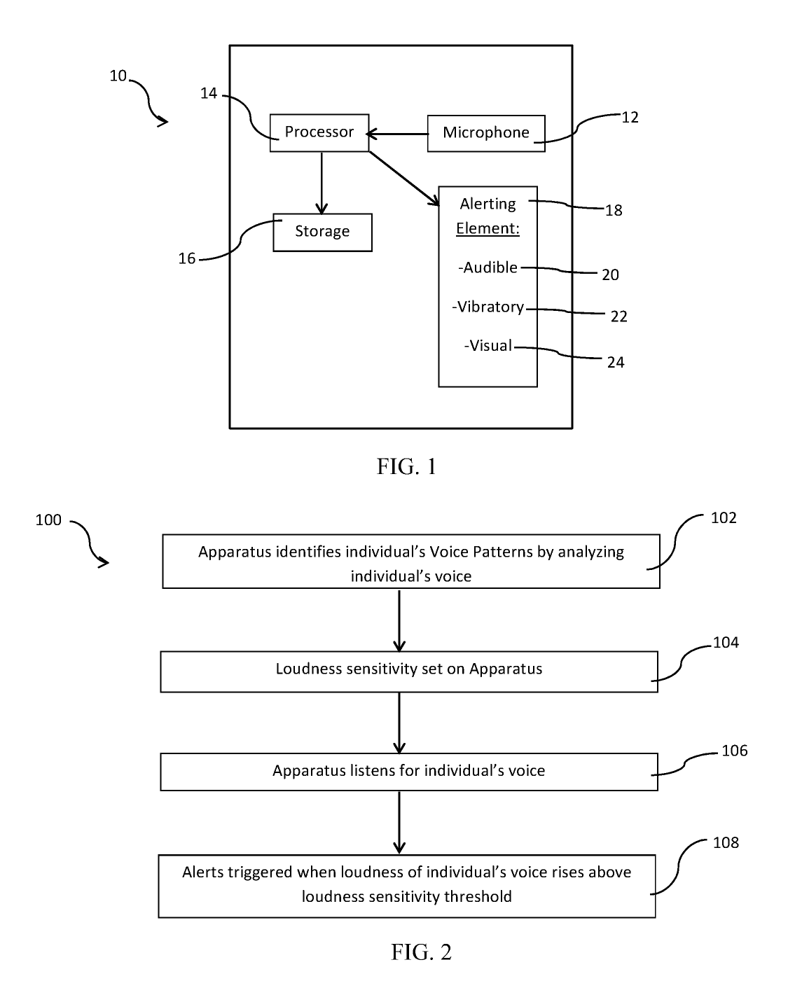

### DETAILED DESCRIPTION OF THE PRESENTLY PREFERRED EMBODIMENTS

The present invention relates to a voice recognition alert notification apparatus, system and methods of using the same. Specifically, the voice recognition alert notification apparatus comprises a device having an audio listening element that is programmed to identify the voice pattern of a particular individual, such that when the loudness of a particular individual's voice rises to a particular pre-defined level, the alert notification apparatus sends a signal to the individual. The present invention may be particularly useful in situations for self-regulation, where an individual, such as a child, is learning to control the loudness level of his or her voice.

Now referring to the drawings, wherein like numerals refer to like parts, an apparatus 10 is provided in an embodiment of the present invention. The apparatus 10 may comprise several components that work together to achieve the purposes of the present invention, namely to listen for an individual's voice to rise above a threshold level, and provide an alert when the individual's voice rises above the threshold level.

Therefore, the apparatus 10 comprises a microphone 12 or other listening element that may be utilized to listen and electronically convert audible signals into electrical signals. The microphone 12 may be interconnected to a processor 14, commonly known as a computer processor, for processing and analyzing the converted audible signals as electrical signals. The processor 14 may be interconnected with a storage module 16 that may provide storage of the information needed and generated by the apparatus 10. Finally, the apparatus 10 may include an alerting element 18 that may be an audible alerting element 20, a vibratory alerting element 22 (or other touch-sensitive alerting element), and/or a visual alerting element 24. The audible alerting element 20 may be a siren, alarm, a vocalization, an instruction, or other like audible signal that may be heard by an individual. The audible alerting element 20 may emanate from a speaker built into the apparatus 10 or may be separated from a main body of the apparatus 10 so as to be placed in closer proximity to the individual's ear. The vibratory element 22 may provide a vibration or other like touch-sensitive alert that may be felt by an individual. The vibratory element 20 may emanate from a vibration-inducing element within the apparatus 10. The visual alerting element 24 may be a light, a flashing light, a visual message or other like visual element. The alerting element 18 may thus alert an individual, and preferably is easily noticeable and recognizable by the individual.

The apparatus 10 of the present invention may have stored therein within the storage module 16 a vocal pattern relating to an individual or other vocal characteristic. A threshold loudness level may be set by a user thereof to set a loudness threshold that may trigger the alerting element 18 when the processor 14 identifies, via listening through the microphone 12, when the individual's voice has a loudness that rises over the loudness threshold. The alerting element 18 may thus be triggered and may send a signal, whether audible, non-audible touch-sensory, such as a vibration, or visual, such as a flashing light, for example, to the individual thereby alerting the individual that his or her voice has risen above the threshold level.

Further, the apparatus 10 of the present invention may further include biometric sensors for tracking other biometric indicators that may indicate whether an individual is overly excited, angry, or having another emotion that he or she may wish to self-regulate. For example, a biometric sensor may detect a user's heart rate, blood pressure, respiration, or other like biological condition that may be utilized, together with the voice loudness data, to trigger the alarm or the alert, whether audible or inaudible.

FIG. 2 illustrates a preferred method 100 of the present invention. In a first step 102, the apparatus may identify an individual's Voice Patterns by analyzing the individual's voice. To do so, the individual may speak into the microphone so that the apparatus 10 obtains a sample of the individual's voice, and may store the same within the storage module 16. The processor 14 may process and analyze the sample of the individual's voice to identify voice pattern characteristics that may be utilized to identify the individual's voice later. Once the characteristics are identified, the characteristics may be stored within the storage module 16.

In step 104, a user of the apparatus 10 may set a loudness sensitivity or threshold on the apparatus. The loudness threshold is preferably the loudness level that, upon the individual's voice rising above the loudness level, the alerting element 18 is triggered. The apparatus 10 may then be set into a “listening mode” whereupon the apparatus 10 listens for audible noise via step 106. The individual's voice may be identified by the processor 14 via listening through the microphone 12 by matching voice pattern characteristics stored within the storage module 16. Alerts are then triggered by the apparatus 10 via step 108 when the individual's voice, identified by the processor 14, rises above the set threshold level. The alert will communicate to the individual that he or she should lower his or her voice.

The present invention thus filters an individual's voice from other noise that may be surrounding the individual. In a preferred embodiment, other noise that does not match the individuals identified and stored characteristics will not trigger the alert element 18, no matter how loud the other noise.

The apparatus 10 may take any form, and may be carried by an individual, such as in his or her pocket, or on his or her body. For example, the apparatus 10 may be in the form of a bracelet, necklace, earrings, headband, or other like element. Preferably, the apparatus 10 may be in the form of a bracelet, similar to a wristwatch, that may be worn on the wrist of the individual and carried within him or her at all times. Likewise, the apparatus 10 may be a module on a smartphone and may be implement via an app on the smartphone that may be carried with the individual at all times.

In addition, the several components may be contained together in a single apparatus or may be separated from each other and connected via wired or wireless connectivity. For example, the microphone 12 may be separate from the remainder of the apparatus 10 and placed in a location close to the individual's head or mouth so as to better listen for the individual's voice. Likewise, the alerting element 18 may be separate from the remainder of the apparatus 10 and placed in a location close to the individual's ears or eyes, or other sensitive location so as to be easily received and identified by the individual, and connected to the remainder of the apparatus 10 via wired or wireless connectivity.

In an alternate embodiment of the present invention, an alert or alarm apparatus is provided having multiple alarm settings that may be utilized by an individual for self-regulation or organizational purposes. Specifically, oftentimes individuals who suffer from organizational issues, such as children, individuals with autism or other like individuals, may have difficulty remembering to do certain tasks throughout the day. An alarm that allows an individual to set multiple alarms throughout the day may allow an individual to better track tasks to be completed and, more precisely, when to complete the tasks. In an embodiment, the alarm apparatus as described herein may be combined with an alarm or alert system, as described above, that alerts an individual when his or her voice loudness level rises above a threshold value.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

I claim:

1. An apparatus comprising:
a microphone;
a processor;
a storage module; and
an alerting element,
wherein the processor is programmed to recognize an individual's voice patterns and to trigger the alerting element when the individual's voice rises above a pre-defined threshold level.

2. A method comprising the apparatus of claim 1, further comprising the steps of:
identifying characteristics of an individual's voice patterns by analyzing the individual's voice via the processor;
storing the characteristics in the storage module;
listening for the individual's voice by matching the individual's voice using the stored characteristics; and
alerting the individual when the individual's voice rises above a threshold loudness level.
